(19) United States
(12) Patent Application Publication
(10) Pub. No.: US 2020/0267116 A1
(43) Pub. Date: Aug. 20, 2020

(54) INTERNET PROTOCOL VERSION SIX ADDRESS MANAGEMENT

(71) Applicant: HEWLETT PACKARD ENTERPRISE DEVELOPMENT LP, Houston, TX (US)

(72) Inventor: Todd Osterberg, Roseville, CA (US)

(21) Appl. No.: 16/280,156

(22) Filed: Feb. 20, 2019

(51) Int. Cl. H04L 29/12

(52) U.S. Cl. CPC H04L 61/2007; H04L 61/6059; H04L 61/6022

(57) ABSTRACT

A network device to monitor and control allotment of internet protocol (IP) version six (IPv6) addresses within a computer network is provided. The network device may cause client devices to fail to obtain an IPv6 address based on network device actions. For example, the network device may: obtain a network packet from an IP network; determine if the network packet is a duplicate address determination (DAD) packet; identify a network client device originating the DAD packet; compare a number of IPv6 addresses already assigned to the network client device to a threshold allotment of addresses; based on a determination that the network client device would exceed the threshold allotment, transmit an address in use message on the IP network; and based on a determination that the network client device has an available address within the threshold allotment, ignore the DAD packet.

### BACKGROUND

Networks of computers that support business activities are often composed of a multitude of infrastructure devices (e.g., computational, storage, and network resources). These infrastructure devices may provide, for example, a cohesive system of coordinated computing devices that support many automated functions for a corporate enterprise. In some cases, these computing devices are connected to a network for communication with each other. Wireless and wired networks may be connected to each other, for example, using a device referred to as an Access Point (AP). Some devices connected to a network as infrastructure devices may perform network monitoring and security checks on network activities. These infrastructure devices may include, but are not limited to, firewalls, network data analyzers (sniffers), network analytics servers, network performance monitors, authentication servers. These and other types of network infrastructure devices may provide data or event information to security or performance monitoring network components. Client devices (both wired and wireless) may perform network operations in their normal course of operation. To function on a network, devices (including client devices) obtain (or are assigned) a network address that is unique to that device. A network address allows routers, switches, and other network infrastructure devices to properly direct traffic (i.e., network packets) throughout the network to its appropriate destination.

One common type of network is an internet protocol (IP) network. Because of the significant growth in number of devices connected to IP networks, a relatively new network address assignment has been introduced. Previous IP networks relied mostly on IP version 4 (IPv4) addressing schemes. Today, IP version 6 (IPv6) is becoming more prevalent and most large networks may include a mix of devices that utilize either IPv4, IPv6, or a combination of the two (e.g., a hybrid transitional network). In IPv4, network address administration is typically controlled via network assignment to client devices (e.g., a client to the network that may also include a server system) from a network server system such as a dynamic host communication protocol (DHCP) server or the like. However, in IPv6 network addresses may be dynamically generated at a client device and then “tested” with the network to determine if that address may be utilized. Further, the number of available network addresses has been dramatically increased in IPv6 over the maximum number of network addresses that were available within IPv4. Accordingly, management of network addresses (e.g., by a network system administrator) has changed in paradigm where address management has shifted from a server side control to where clients may generate their own addresses and a vastly larger number of available addresses are administered.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not perform serial processing and therefore those functions may be performed in an order different than shown or possibly in parallel with each other. For a detailed description of various examples, reference will now be made to the accompanying drawings, in which:

FIG. 1 is a functional block diagram representing an example of a network segment of a hybrid network (e.g., mix of IPv4 and IPv6 addressing) including a client wired device, a client wireless device, a network controller (e.g., access point (AP)), a switch, and a network appliance to assist in management of IPv6 address use, according to one or more disclosed examples;

FIG. 2 is a flow diagram illustrating an example method representing a continuously looping control function that may execute on the network appliance (e.g., server side) to assist in administration of IPv6 address use by client devices, according to one or more disclosed examples;

FIG. 3 is a flow diagram illustrating an example method representing a loop flow that may be performed by a network client device as part of generating and initiating use of an IPv6 network address, according to one or more disclosed examples;

FIG. 4 is a functional flow diagram representing an example method to illustrate a combination of server side and client-side functionality with respect to obtaining and using IPv6 addresses, according to one or more disclosed examples;

FIG. 5 is an example computing device with a hardware processor and accessible machine-readable instructions that may be used to compile and execute the algorithm that provides the example method 400 of FIG. 4, according to one or more disclosed examples;

FIG. 6 represents a computer network infrastructure that may be used to implement all, or part of the disclosed IPv6 network address control techniques, according to one or more disclosed implementations; and

FIG. 7 illustrates a computer processing device that may be used to implement the functions, modules, processing platforms, execution platforms, communication devices, and other methods and processes of this disclosure.

### DETAILED DESCRIPTION

Illustrative examples of the subject matter claimed below will now be disclosed. In the interest of clarity, not all features of an actual implementation are described for every example implementation in this disclosure. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

As briefly mentioned above, an Internet Protocol Version 6 address (IPv6 address) is a numerical label that is used to identify a network interface of a computer or a network node participating in an IPv6 computer network. An IP address serves the purpose of identifying an individual network interface of a host, locating it on the network, and thus permitting the routing of IP packets between hosts. For routing, IP addresses are present in fields of the packet header where they indicate the source and destination of the packet.

IPv6 is the successor to the first addressing infrastructure of the Internet, Internet Protocol version 4 (IPv4). In contrast to IPv4, which defined an IP address as a 32-bit value, IPv6 addresses have a size of 128 bits. Therefore, IPv6 has a vastly enlarged address space compared to IPv4. IPv6 includes what is sometimes referred to as stateless address autoconfiguration. Thus, on system startup, a node automatically creates a link-local address on each IPv6-enabled interface, even if globally routable addresses are manually configured or obtained through “configuration protocols.” The node does so independently and without any prior configuration by stateless address autoconfiguration (SLAAC), using a component of the neighbor discovery protocol (NDP). This link-local address is selected with the prefix fe80::/64.

In IPv4, typical “configuration protocols” include dynamic host configuration protocol (DHCP) or point to point protocol (PPP). In DHCP, a server assigns an address to a network client device (e.g., upon request) and in PPP a one to one connection is established between two points in the network. In PPP a client may directly connect with another device that is connected to the Internet (and has an IP address) as opposed to the client having a direct network connection to the Internet. Although DHCPv6 exists, IPv6 devices normally use NDP to create a globally routable unicast address: the device sends router solicitation requests and an IPv6 router responds with a prefix assignment. For example, an IPv6 device may populate the lower 64 bits of IPv6 addresses with a 64-bit interface identifier in modified EUI-64 format. This identifier is usually shared by all automatically configured addresses of that interface, which has the advantage that only one multicast group needs to be joined for neighbor discovery. For example, a multicast address is used that may be formed from the network prefix ff02::1:ff00:0/104 and the 24 least significant bits of the address.

Modified EUI-64 represents a 64-bit interface identifier that is most commonly derived from an interfaces 48-bit media access control (MAC) address. For example, a MAC address of 00-0C-29-0C-47-D5 is turned into a 64-bit EUI-64 by inserting FF-FE in the middle to form a modified EUI-64 of 00-0C-29-FF-FE-0C-47-D5. Additionally, the assignment of a unicast IPv6 address to an interface involves an internal test for the uniqueness (referred to as duplicate address detection (DAD)) of that address using Neighbor Solicitation and Neighbor Advertisement (e.g., ICMPv6 type 135 and 136) messages. While in the process of establishing uniqueness, an address has a tentative state (e.g., a tentative address).

Continuing with this example, the client may then join the solicited-node multicast address for the tentative address (if not already done so) and send neighbor solicitations, with the tentative address as target address and the unspecified address (J128) as source address. The client may also join the all-hosts multicast address ff02:1, so it will be able to receive Neighbor Advertisements.

If, while attempting to establish use of a tentative address, a client receives a neighbor solicitation with its own tentative address as the target address, then that tentative address is determined (by the client) to be non-unique. Similarly, if the client receives a neighbor advertisement with the tentative address as the source of the advertisement, the tentative address is determined (by the client) as non-unique. If a tentative address is determined to be non-unique, the client may generate a new tentative address and try again. Only after having successfully established that an address is unique may that address be assigned and used by an interface. This process of assigning an address for use by an interface may be referred to as “binding” the address to the interface. Thus, a tentative address may be established for use by a client interface by determining that it is available (e.g., unique) and binding the tentative address to an interface—causing the tentative address to lose its “tentative” state.

When an address is assigned to an interface it gets the status “preferred”, which the address holds during its preferred-lifetime. After that lifetime expires the status becomes “deprecated” and no new connections should be made using this address. The address becomes “invalid” after its valid-lifetime also expires; the address may then be removed from the interface and may be assigned somewhere else on the Internet (or within a local network such as a corporate infrastructure network or university network). It should be noted that, in most cases, the lifetime does not expire because new Router Advertisements (RAs) may refresh the timers. However, if there are no more RAs, eventually the preferred lifetime elapses and the address becomes “deprecated”.

The globally unique and static MAC addresses, used by stateless address autoconfiguration to create interface identifiers, may additionally offer an opportunity to track user equipment across time and IPv6 network prefix changes. To reduce the prospect of a user identity being permanently tied to an IPv6 address portion, a node may create temporary addresses with interface identifiers based on time-varying random bit strings and relatively short lifetimes (hours to days), after which they are replaced with new addresses. Temporary addresses may be used as source address for originating connections, while external hosts may use a public address by querying the Domain Name System. Network interfaces configured for IPv6 may use temporary addresses by default in different operating systems.

In short, IPv6 represents a different paradigm for: address space, address generation, address assignment, and use by a client device when compared to IPv4. Notably, in IPv4 server devices controlled address use by client devices whereas in IPv6 client devices generate their own addresses. As a result, some environments such as a bring your own device (BYOD) environment have lost a measure of control with respect to address use by client devices. For example, an environment such as a university campus, hotel and conference center, sporting complex, or other environment where a large number of transient devices (and users) are present may face a situation where some client devices are disproportionately using too many system resources, in part by using a large number of network addresses. Disclosed systems and techniques address this issue, in part, by providing a network appliance configured to throttle the number of addresses allowed on a given client device. In some implementations, disclosed systems may provide an administrative control in BYOD environments to limit the number of IPv6 addresses a client can obtain/use such that the total number of IPv6 ND entries does not exceed hardware capacities resulting in a network outage. This throttling may be based on a configurable number of addresses that can be transitioned from tentative status to preferred status by the client device. Accordingly, disclosed systems represent an improvement to the art of network administration by providing an improved functioning of a system configured to manage network address assignment in IPv6 or IPv4/IPv6 hybrid networks.

Disclosed systems may include an appliance connected to the network to “watch” for a client attempting to transition from a temporary address to a preferred address. This appliance may detect when an IPv6 client is performing duplicate address detection (DAD). As mentioned above, when a client is performing this type of operation, frames are transmitted by that client to validate if the desired address is in use. The DAD frames contain the client's MAC address as well as the ‘target address’ (the address they wish to use). Capturing these frames and counting the number of DAD requests per MAC address would provide one example mechanism by which the appliance is able to limit a client device to a specific number of IPv6 addresses. Other types of determination that a client device (or user) is requesting addresses that would exceed their allotted amount could also be implemented. For example, a user may be associated with each device in use by that user and a total number of addresses per identified user may be controlled using similar techniques.

In a university setting (or other large-scale BYOD environment), it may be expected that there may be many students that each have multiple devices (e.g., phone, laptop, tablet, etc.). Accordingly, a single user may have multiple devices connected to a wireless network in a transient manner and they may all be active for overlapping periods of time. Further, different application configurations and hardware configurations may allow a single device to consume multiple addresses. Even though IPv6 may have a vast address space, there is a finite amount of IPv6 table size in network infrastructure devices used to facilitate network traffic. Accordingly, each hardware device (router, switch, bridge, etc.) may be able to support a maximum number of addresses before that hardware device runs into a resource constrained situation that may result in performance degradation of the device or even failure.

In one example, if a wireless client device is attempting to validate a new temporary address, the disclosed network appliance could repeatedly cause the DAD process to fail and the wireless client operating system would eventually stop asking for a new address. In an alternate implementation, if a wired device was attempting to exceed a threshold or acting in a malicious manner, a command could be sent to an appropriate switch to disable the port by which that wired device is connected to the network. Thus, preventing the wired device from participating in any further network traffic. Other implementations are also possible.

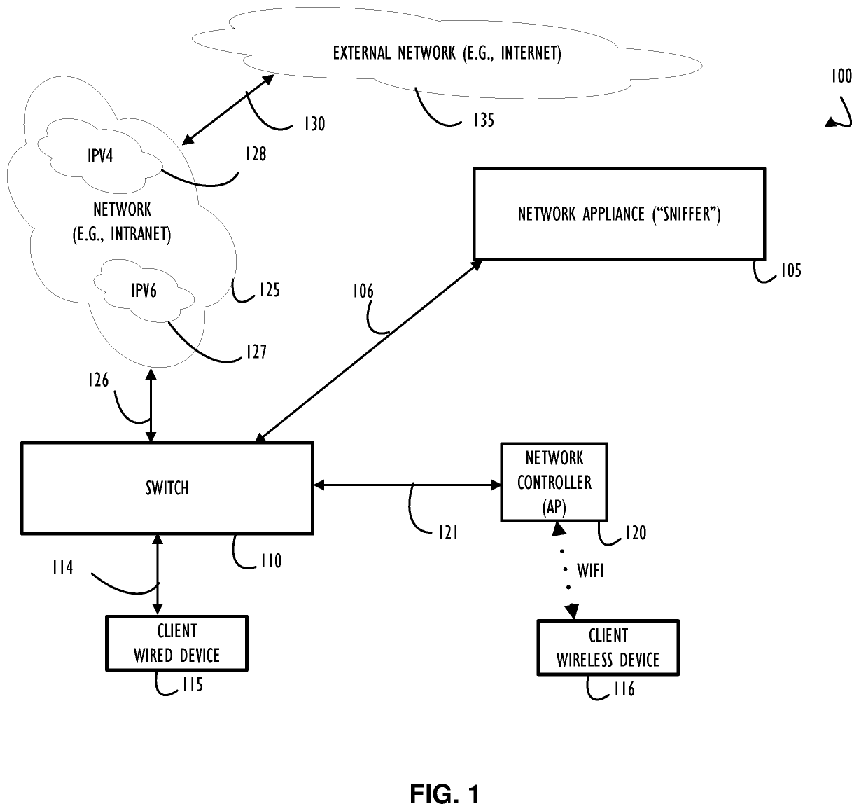

Referring now to FIG. 1, network segment 100 represents an example of a network appliance 105, a switch 110, a client wired device 115, and a client wireless device 116 connected to switch 110 via network controller 120 which is illustrated as an access point (AP). Network segment 100 is additionally connected, via link 126 and switch 110, to network 125 that is illustrated as a hybrid network containing addresses for IPv6 127 and addresses for IPv4 128. Network 125 is illustrated to represent a corporate network or a university network, as examples, that includes the devices in network segment 100 and is additionally connected to external network 135 which may be the Internet or some other remote network (e.g., a different corporate network). As illustrated network 125 is connected via link 130 to external network 135 and link 130 may represent an Internet service provider (ISP) or some sort of dedicated link between two corporate networks (e.g., networks supported by two different data centers).

In network segment 100, network appliance 105 is connected to switch 110 via link 106. All links illustrated in network segment 100 represent bi-directional links, however, in some cases there may be devices connected to a network with a unidirectional link. Client wired device 115 is illustrated as connected to switch 110 via wired link 114. Client wireless device 115 utilizes a WiFi® (e.g., wireless radio) connection to network controller 120 which is, in turn, connected via wired link 121 to switch 110.

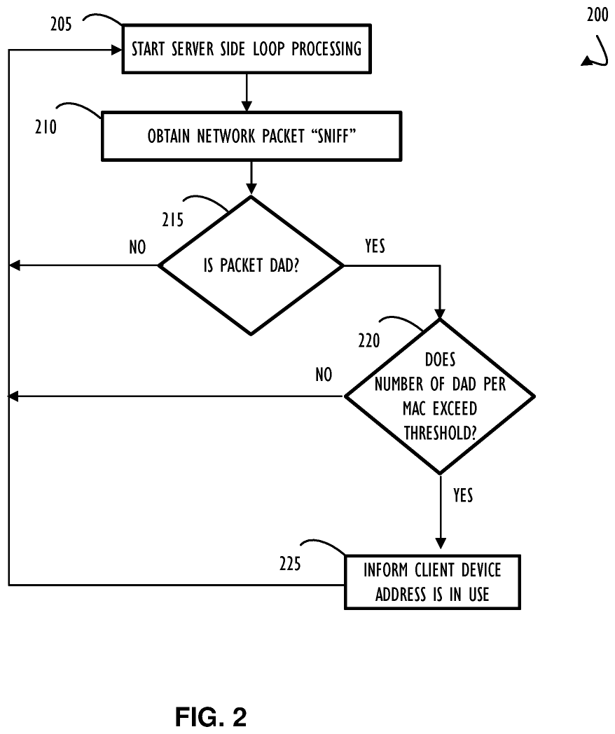

As explained further below with reference to FIGS. 2-4, each of client wired device 115 and client wireless device 116 (collectively referred to in this example as “client devices”) may wish to communicate on network segment 100 using IPv6 addresses. These client devices may also support IPv4 addressing but that may not be specifically pertinent to the aspects of this disclosure. In order to obtain an IPv6 address, each client device may generate a temporary IPv6 address and transmit a message out to network segment 100 (via switch 110) to determine if the client device may validate and use that generated temporary address.

According to disclosed implementations, network appliance 105 may recognize the request for validation (e.g., a DAD message) and determine if the requesting device has exceeded a configurable threshold for an allowed number of IPv6 address. If the client device (or associated user in other examples) has exceeded their allotment, network appliance 105 may respond to the DAD message in a manner to inform the client device that they may not use the temporary address “because the temporary address is already in use.” Specifically, network appliance 105 may lie to the requesting client in an effort to force the validation request to fail validation at the client device. That is, the temporary address will not be considered unique from the client device perspective because the validation failed. As a result, the client device, if performing in compliance with networking standards, will not bind the temporary address to an interface. This process of requesting for validation may be repeated a number of times by the client device and correspondingly failed based on the actions of network appliance 105. However, if the client device is performing in accordance with networking standards, the client device will cease attempting to generate and validate a new address after a reasonable number of attempts.

Referring now to FIG. 2, an example method 200 represents a continuously looping control function that may execute on a network appliance (e.g., server-side) to assist in administration of IPv6 address use by client devices, according to one or more disclosed example implementations. Example method 200 begins at block 205 where server-side loop processing begins. Example method 200 may be implemented on a network appliance such as network appliance 105 of FIG. 1 or may be implemented on some other type of network infrastructure component. That is, functionality as described herein as being performed by a separate device may be incorporated into an already existing device (e.g., by installing additional software). Block 210 indicates that the network appliance may obtain network packets from the network to interrogate them. Because these network packets were not necessarily destined for the network appliance, the act of obtaining may sometimes be referred to as “sniffing” the network. The act of sniffing may be performed without detriment to the transmission of the packet through the networks and is typically performed in a passive manner.

Decision 215 indicates that the network appliance may make a determination as to if this packet is a DAD packet. That is, a packet from a client device attempting to validate a temporary IPv6 address. If not, the NO prong of decision 215, the network appliance may simply ignore that packet. However, if the packet is a DAD packet, the YES prong of decision 215, flow continues to decision 220 where a determination may be made as to if the DAD packet is associated with a device that has exceeded a configurable threshold. For example, a network appliance may be configured to allow five (5) addresses for a particular client device based on a MAC address. Accordingly, if a sixth (6th) address is requested, the threshold would be exceeded and the YES prong of decision 220 would be followed. However, if the threshold is not exceeded, the NO prong of decision 220 is followed and the network appliance again ignores the packet. Responsive to a threshold being exceeded, the YES prong of decision 220, flow continues to block 225 where the network appliance responds with an “address in use” message. As mentioned above, if a client receives an “address in use” message, and is performing in accordance with networking standards, the client will discard that temporary address and either attempt to generate another or cease attempting to obtain a new address.

In this example, the allotment is described as being per MAC address. However, other measures of allotment may be used and not depart from the scope of this disclosure. For example, if a device is determined to have multiple network interface cards (NICs) and each NIC has a different MAC address (as expected), then the total number of addresses (e.g., the allotment) may be based on a total number for that device. Further, the allotment may be configured with respect to an identified user. In that implementation, a user may be allowed an allotted number of addresses across all devices associated with that user. Other types of allotments and configurable thresholds are also possible. In any case, disclosed techniques attempt to prevent a client device from properly validating their temporary address when an associated allotment threshold has been reached.

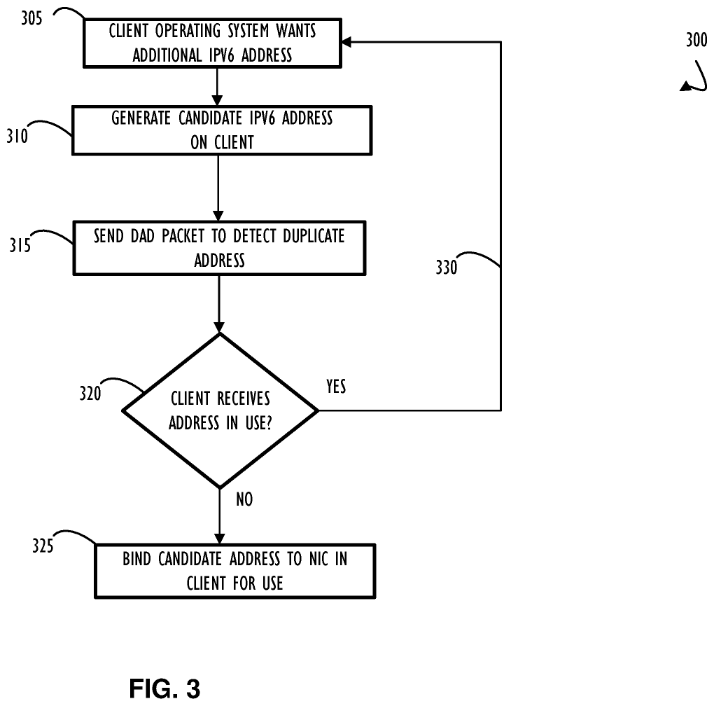

Referring now to FIG. 3, an example method 300 is illustrated to represent a loop flow that may be performed by a network client device as part of generating and initiating use of an IPv6 network address. Example method 300 begins at block 305 where a client operating system (OS) wants to use a new (or additional) IPv6 address. Block 310 indicates that the client device generates a candidate IPv6 address which, as explained above, is a temporary address at this point in time in the process. Block 315 indicates that the client device sends a DAD packet out to the network to determine if any other device may claim ownership of that candidate address. Decision 320 indicates that the client device may make a determination as to receiving an address in use message. If the client does not receive an address in use message, the NO prong of decision 320, the client device may then (as illustrated in block 325) bind the candidate address to an interface and begin using that address in a preferred (rather than temporary) state. However, if at decision 320 an address in use message is received (e.g., from the above discussed network appliance), the YES prong of decision 320, flow may continue along link 330 to loop back to 305. In this situation (i.e., link 330), the candidate address does not transition from temporary address to preferred address and may be discarded by the client device. Further, as discussed above, link 330 may only be traversed a reasonable number of times on a properly functioning client device such that upon return via link 330, the client OS (at block 305) may no longer “want” an additional IPv6 address.

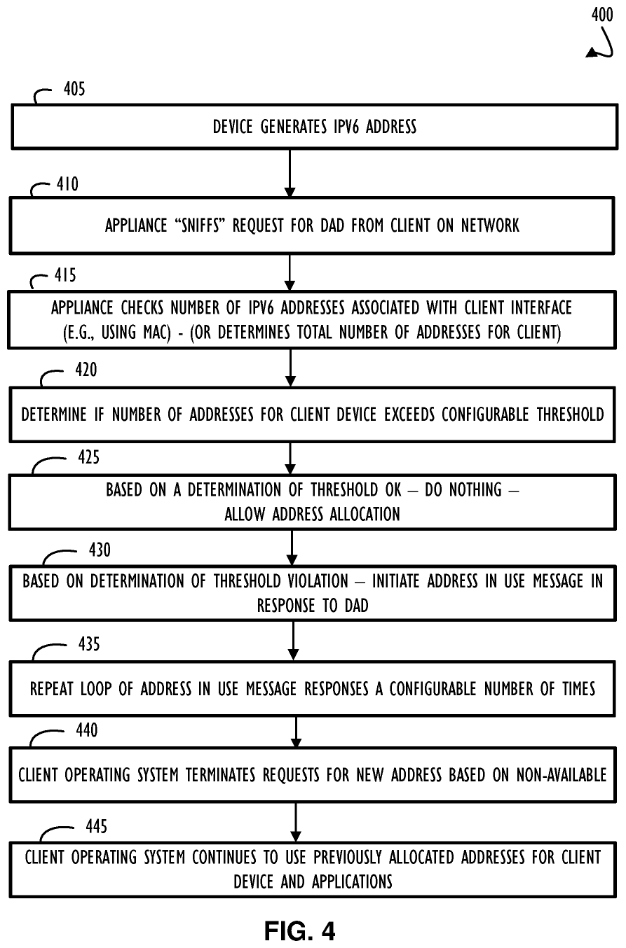

Referring now to FIG. 4, an example method 400 is illustrated as an overall method including a combination of server-side and client-side functionality with respect to obtaining and using IPv6 addresses, according to one or more disclosed implementations. Example method 400 begins at block 405 where a device generates an IPv6 temporary address. Block 410 indicates that an appliance (e.g., network appliance 105) sniffs the packet and determines the packet represents a DAD message. Block 415 indicates that the appliance may check to see if a threshold allotment (as described above) has been exceeded. Block 420 indicates that the determination of exceeding one or more thresholds may be made by the network appliance. Block 425 indicates that based on a determination that an allotment threshold is not exceeded, the network appliance may ignore the packet and do nothing further (e.g., return to block 405 for the next packet). Block 430 indicates that based on a determination that an allotment threshold has been exceeded, the network appliance may initiate an address in use message as a response to the DAD message. Upon receipt of the address in use message, the client should not validate the temporary address. Block 435 indicates that this looping may be repeated by either or both of the client device attempting to validate a new address and the network appliance checking/preventing use of that new address. Block 440 indicates that, based on OS implementation criteria of the client device, the client device may stop requesting a new address (and thus be limited to their allotment as desired). Block 445 indicates that, again based on OS implementation criteria, the client device may continue operation with previously obtained and validated IP addresses (possibly even an IPv4 address).

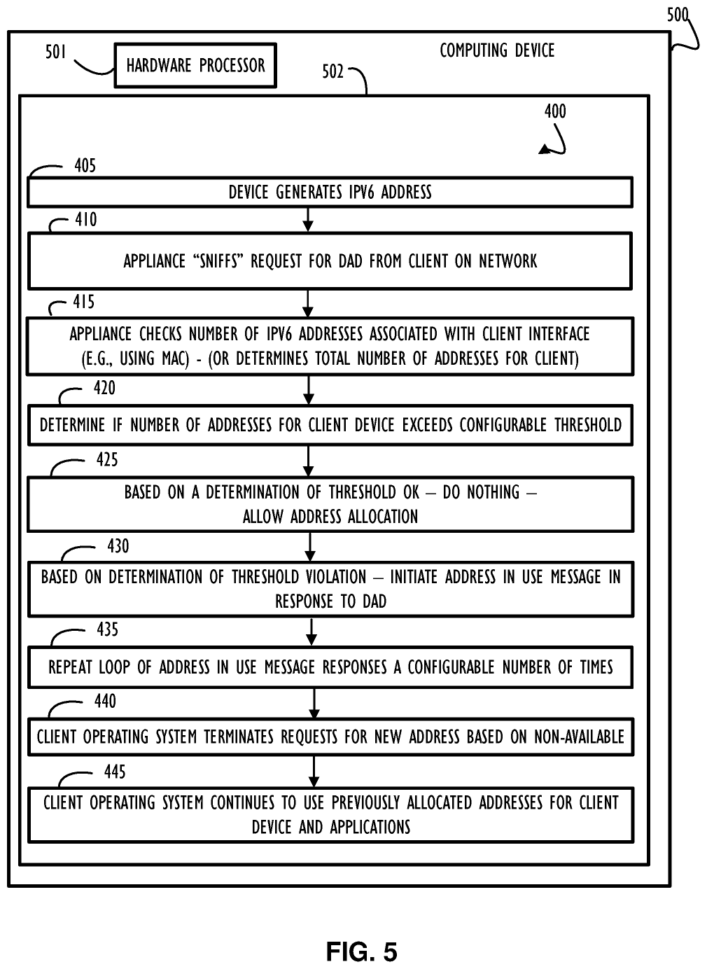

FIG. 5 is an example computing device 500, with a hardware processor 501, and accessible machine-readable instructions stored on a machine-readable medium 502 for implementing one example system for managing IPv6 network addresses (that are generated at a client devices) within an IPv6 network or a hybrid network using a combination of IPv4 and IPv6 addresses concurrently, according to one or more disclosed example implementations. FIG. 5 illustrates computing device 500 configured to perform the flow of method 400 as an example. However, computing device 500 may also be configured to perform the flow of other methods, techniques, functions, or processes described in this disclosure. In this example of FIG. 5, machine-readable storage medium 502 includes instructions to cause hardware processor 501 to perform blocks 405-445 discussed above with reference to FIG. 4.

A machine-readable storage medium, such as 502 of FIG. 5, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

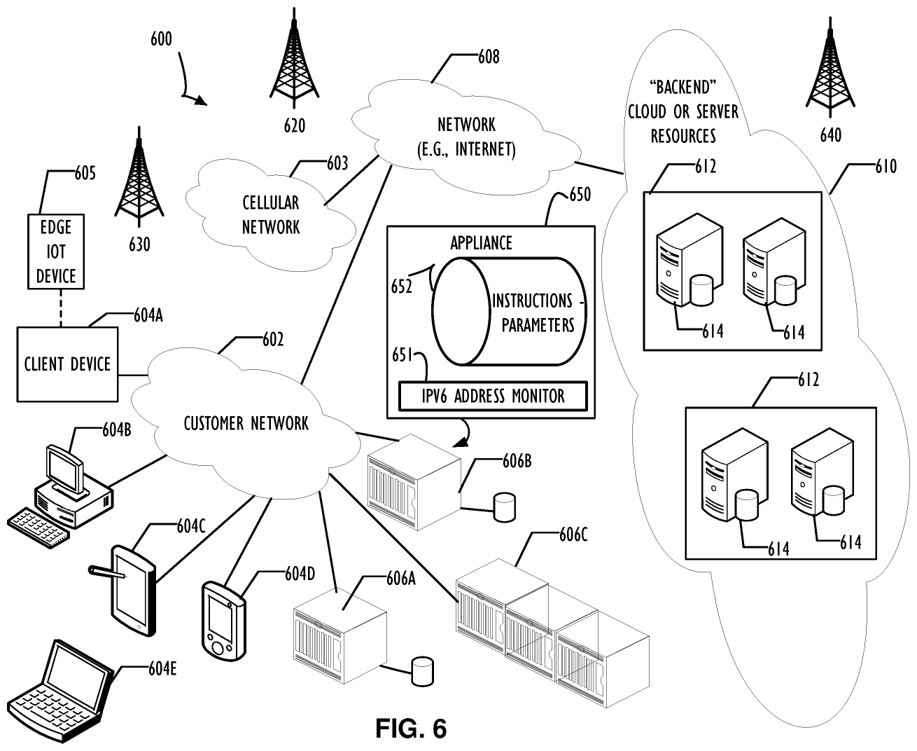

Referring now to FIG. 6, a computer network infrastructure 600 is illustrated. Computer network infrastructure 600 is used to illustrate a network where a mixture of IPv4 addresses may be assigned to network client devices along with IPv6 addresses being generated for use by network client devices. Computer network infrastructure 600 includes an appliance 650 that further includes an IPv6 network address monitor 651 function and instructions/parameters 651 (e.g., a stored set of instructions and parameters to configure and control functionality of appliance 650) that may be used to implement all or part of the disclosed techniques for managing network client device use of IPv6 addresses, according to one or more disclosed examples. Further, network infrastructure 600 includes a set of networks where implementations of the present disclosure may operate and be utilized. Network infrastructure 600 comprises a customer network 602, network 608 (e.g., the Internet), cellular network 603, and a cloud service provider network 610. In one example implementation, the customer network 602 may be a local private network, such as local area network (LAN) that includes a variety of network devices that include, but are not limited to switches, servers, and routers. Within customer network 602 there are illustrated a plurality of wireless access points 650 that may each facilitate wireless network connectivity within customer network 602. There may be one or more WLANs supported with in customer network 602 and each of these WLANs may be logically divided into one or more VLANs. Different WLANs within customer network 602 may utilize IPv4 addressing, IPv6 addressing, or a combination of the two representing a hybrid IPv4/IPv6 addressed network as described above. Some or all of the WLANs within customer network 602 may be implemented with connections to network address control appliance 650 as disclosed herein.

Each of these networks may contain wired or wireless programmable devices and operate using any number of network protocols (e.g., TCP/IP) and connection technologies (e.g., WiFi® networks, or Bluetooth®). In another example, customer network 602 represents an enterprise network that could include or be communicatively coupled to one or more local area networks (LANs), virtual networks, data centers (see FIG. 2) and/or other remote networks (e.g., 608, 610). In the context of the present disclosure, customer network 602 may include a network device configured as network appliance 650 described above. Additionally, customer network 602 may represent a target network supported by disclosed implementations of network address control.

As shown in FIG. 6, customer network 602 may be connected to one or more client devices 604A-E and allow the client devices 604A-E to communicate with each other and/or with cloud service provider network 610, via network 608 (e.g., Internet). Client devices 604A-E represent devices that are both network client devices and functional client devices, in part because of their role within the enterprise network. For example, client devices 604A-E may be computing systems such as desktop computer 604B, tablet computer 604C, mobile phone 604D, laptop computer (shown as wireless) 604E, and/or other types of computing systems generically shown as client device 604A. Client devices may be authenticated to a network and may be supporting an authenticated session of a user (or users) where each user has authenticated using an authentication technique (e.g., single sign on using a simple password, multi-factor authentication, or even biometric authentication). In any case, client devices 604A-E may be associated with authentication attributes of one or more users and may be associated with at least one IPv4 address per network interface and one or more IPv6 addresses on one or more network interfaces.

Network infrastructure 600 may also include other types of devices generally referred to as Internet of Things (IoT) (e.g., edge IoT device 605) that may be configured to send and receive information via a network to access cloud computing services or interact with a remote web browser application (e.g., to receive just-in-time authentication information). Edge IoT device 605 may utilize either IPv4 or IPv6 addressing techniques.

FIG. 6 also illustrates that customer network 602 includes local compute resources 606A-C that may include a server, access point, router, or other device configured to provide for local computational resources and/or facilitate communication amongst networks and devices. For example, local compute resources 606A-C may be one or more physical local hardware devices. Local compute resources 606A-C may also facilitate communication between other external applications, data sources (e.g., 606A and 606B), and services, and customer network 602. In some example implementations, local compute resources may host one or both of the network analytics server or the NAS. Additionally, input data sources to the network analytics server may be provided via one or more of local compute resources 606A-C.

Network infrastructure 600 also includes cellular network 603 for use with mobile communication devices. Mobile cellular networks support mobile phones and many other types of mobile devices such as laptops etc. Mobile devices in network infrastructure 600 are illustrated as mobile phone 604D, laptop computer 604E, and tablet computer 604C. A mobile device such as mobile phone 604D may interact with one or more mobile provider networks as the mobile device moves, typically interacting with a plurality of mobile network towers 620, 630, and 640 for connecting to the cellular network 603.

FIG. 6 illustrates that customer network 602 is coupled to a network 608. Network 608 may include one or more computing networks available today, such as other LANs, wide area networks (WAN), the Internet, and/or other remote networks, in order to transfer data between client devices 604A-D and cloud service provider network 610. Each of the computing networks within network 608 may contain wired and/or wireless programmable devices that operate in the electrical and/or optical domain.

In FIG. 6, cloud service provider network 610 is illustrated as a remote network (e.g., a cloud network) that is able to communicate with client devices 604A-E via customer network 602 and network 608. The cloud service provider network 610 may act as a platform that provides additional computing resources to the client devices 604A-E and/or customer network 602. In one example implementation, cloud service provider network 610 includes one or more data centers 612 with one or more server instances 614. Cloud service provider network 610 may also include one or more frames representing a scalable compute resource that may implement the techniques of this disclosure. Each of the disclosed network address management techniques may be implemented for one or more data centers (not specifically illustrated) that may benefit from disclosed techniques for additional network address management. For example, if the data center were supporting a university with a large number of students and a correspondingly large number of mobile or transient devices.

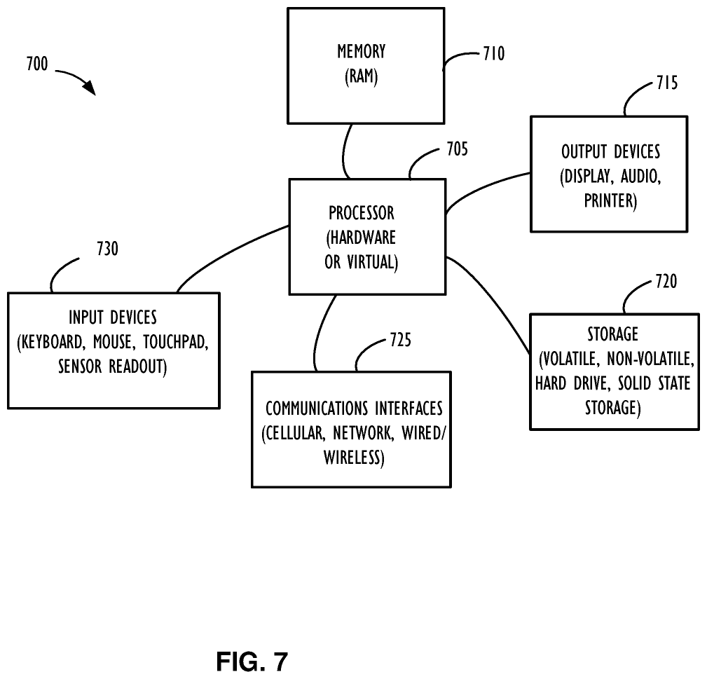

FIG. 7 illustrates a computing device 700 that may be used to implement the functions, modules, processing platforms, execution platforms, communication devices, and other methods and processes of this disclosure. For example, different functionality (e.g., functional modules of FIG. 2) for network address management appliance may be implemented by different functional modules that may execute directly on physical hardware or be implemented with at least one level of abstraction from the physical processors and utilize virtualization. For example, computing device 700 illustrated in FIG. 7 could represent a client device or a physical server device and include either hardware or virtual processor(s) depending on the level of abstraction of the computing device. In some instances (without abstraction), computing device 700 and its elements, as shown in FIG. 7, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware.

As also shown in FIG. 7, computing device 700 may include one or more input devices 730, such as a keyboard, mouse, touchpad, or sensor readout (e.g., biometric scanner) and one or more output devices 715, such as displays, speakers for audio, or printers. Some devices may be configured as input/output devices also (e.g., a network interface or touchscreen display). User-initiated actions may be input via these types of user interfaces.

Computing device 700 may also include communications interfaces 725, such as a network communication unit that could include a wired communication component and/or a wireless communications component, which may be communicatively coupled to processor 705. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 7, computing device 700 includes a processing element such as processor 705 that contains one or more hardware processors, where each hardware processor may have a single or multiple processor core. In one implementation, the processor 705 may include at least one shared cache that stores data (e.g., computing instructions) that are utilized by one or more other components of processor 705. For example, the shared cache may be a locally cached data stored in a memory for faster access by components of the processing elements that make up processor 705. In one or more implementations, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 7, the processing elements that make up processor 705 may also include one or more of other types of hardware processing components, such as graphics processing units (GPU), application specific integrated circuits (ASICs), field-programmable gate arrays (FPGAs), and/or digital signal processors (DSPs).

FIG. 7 illustrates that memory 710 may be operatively and communicatively coupled to processor 705. Memory 710 may be a non-transitory medium configured to store various types of data. For example, memory 710 may include one or more storage devices 720 that comprise a non-volatile storage device and/or volatile memory. Volatile memory, such as random-access memory (RAM), can be any suitable non-permanent storage device. The non-volatile storage devices 720 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 720 may be used to store overflow data if allocated RAM is not large enough to hold all working data. The non-volatile storage devices 720 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 705. In one implementation, the compiling process of the software program may transform program code written in a programming language to another computer language such that the processor 705 is able to execute the programming code. For example, the compiling process of the software program may generate an executable program that provides encoded instructions (e.g., machine code instructions) for processor 705 to accomplish specific, non-generic, particular computing functions.

After the compiling process, the encoded instructions may then be loaded as computer executable instructions or process steps to processor 705 from storage device 720, from memory 710, and/or embedded within processor 705 (e.g., via a cache or on-board ROM). Processor 705 may be configured to execute the stored instructions or process steps in order to perform instructions or process steps to transform the computing device into a non-generic, particular, specially programmed machine or apparatus. Stored data, e.g., data stored by a storage device 720, may be accessed by processor 705 during the execution of computer executable instructions or process steps to instruct one or more components within the computing device 700.

A user interface (e.g., output devices 715 and input devices 730) can include a display, positional input device (such as a mouse, touchpad, touchscreen, or the like), keyboard, or other forms of user input and output devices. The user interface components may be communicatively coupled to processor 705. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 700 may comprise other components well known in the art, such as sensors, powers sources, and/or analog-to-digital converters, not explicitly shown in FIG. 7.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method to limit internet protocol (IP) version six (IPv6) addresses in use by a network client device, the method comprising:
obtaining a network packet from an IP network;
determining if the network packet is a duplicate address determination (DAD) packet;
identifying a first network client device originating the DAD packet;
comparing a number of IPv6 addresses already assigned to the first network client device to a threshold allotment of addresses;
based on a determination that the first network client device would exceed the threshold allotment, transmitting an address in use message on the IP network; and
based on a determination that the first network client device has an available address within the threshold allotment, ignoring the DAD packet.

2. The computer-implemented method of claim 1, wherein identifying the first network client device includes identifying based on a media access control (MAC) address.

3. The computer-implemented method of claim 1, wherein the threshold allotment includes a set of devices in addition to the first network client device.

4. The computer-implemented method of claim 3, wherein each of the set of devices includes devices associated with a user determined to be using the first network client device.

5. The computer-implemented method of claim 3, wherein the DAD packet is ignored when the threshold allotment is exceeded based on a determination that the first network client device has zero allotted IPv6 addresses.

6. The computer-implemented method of claim 1, wherein the first network client device is determined to have multiple network interfaces having multiple MAC addresses and the threshold allotment includes all addresses assigned to the multiple MAC addresses.

7. A computer device comprising:
a processing device communicatively coupled to a network interface; and
a memory storing instructions, that when executed by the processing device, cause the computer device to:
obtain a network packet from an IP network;
determine if the network packet is a duplicate address determination (DAD) packet;
identify a first network client device originating the DAD packet;
compare a number of IPv6 addresses already assigned to the first network client device to a threshold allotment of addresses;
based on a determination that the first network client device would exceed the threshold allotment, transmit an address in use message on the IP network; and
based on a determination that the first network client device has an available address within the threshold allotment, ignore the DAD packet.

8. The computer device of claim 7, wherein the instructions to cause the computer device to obtain a network packet from the IP network include instructions to cause the computer device to sniff the IP network using the network interface.

9. The computer device of claim 8, wherein the computer device sniffs the IP network in a passive manner without impacting transmission of the network packet through the IP network.

10. The computer device of claim 7, wherein the instructions to cause the computer device to identify the first network client device include instructions to identify based on a media access control (MAC) address.

11. The computer device of claim 7, wherein the threshold allotment includes a set of devices in addition to the first network client device.

12. The computer device of claim 11, wherein each of the set of devices includes devices associated with a user determined to be using the first network client device.

13. The computer device claim 11, wherein the DAD packet is ignored when the threshold allotment is exceeded based on a determination that the first network client device has zero allotted IPv6 addresses.

14. The computer device of claim 7, wherein the first network client device is determined to have multiple network interfaces having multiple MAC addresses and the threshold allotment includes all addresses assigned to the multiple MAC addresses.

15. The computer device of claim 7, wherein the computer device is configured as a network appliance.

16. A non-transitory computer readable medium comprising computer executable instructions that, when executed by one or more processing units, cause the one or more processing units to:
obtain a network packet from an IP network;
determine if the network packet is a duplicate address determination (DAD) packet;
identify a first network client device originating the DAD packet;
compare a number of IPv6 addresses already assigned to the first network client device to a threshold allotment of addresses;
based on a determination that the first network client device would exceed the threshold allotment, transmit an address in use message on the IP network; and
based on a determination that the first network client device has an available address within the threshold allotment, ignore the DAD packet.

17. The non-transitory computer readable medium of claim 16, wherein the instructions to cause the one or more processing units to obtain a network packet from the IP network include instructions to cause the one or more processing units to sniff the IP network using a network interface.

18. The non-transitory computer readable medium of claim 17, wherein the one or more processing units sniff the IP network in a passive manner without impacting transmission of the network packet through the IP network.

19. The non-transitory computer readable medium of claim 16, wherein the instructions to cause the one or more processing units to identify the first network client device include instructions to identify based on a media access control (MAC) address.

20. The non-transitory computer readable medium of claim 16, wherein the threshold allotment includes a set of devices in addition to the first network client device.
